(19) United States
(12) Patent Application Publication
(10) Pub. No.: US 2018/0166953 A1
(43) Pub. Date: Jun. 14, 2018

(54) Electromagnetic Shielding System of Eectric Vehicle's Driving Motor

(71) Applicant: Lei HAN, Beijing (CN)

(72) Inventor: Lei HAN, Beijing (CN)

(21) Appl. No.: 15/577,768

(22) PCT Filed: May 16, 2016
(86) PCT No.: PCT/CN2016/082210

§ 371 Date: Dec. 21, 2017

(30) Foreign Application Priority Data
Jun. 12, 2015 (CN) 201510334961.0

(51) Int. Cl. H02K 11/22; H02K 5/20; H02K 5/22; H02K 7/00; H02K 7/08; H02K 7/14; H02K 9/06; H02K 9/19; H02K 11/40; H02K 11/21; B60R 16/03

(52) U.S. Cl. CPC H02K 11/022; H02K 5/20; H02K 5/225; H02K 7/006; H02K 7/083; H02K 7/14; B60Y 2410/114; H02K 9/19; H02K 11/40; H02K 11/21; B60R 16/03; B60Y 2400/60; H02K 9/06

(57) ABSTRACT

To form the electromagnetic shielding system of electric vehicle's drive motor, the drive motor's power surge protection devices, signal lines and control line protection devices are installed between the outer shield and the drive motor to absorb the induced current which is caused by the motor's electromagnetic field around the power lines and signal lines. In this way, the induced current may not penetrate the shield and form another strong magnetic field, and the drive motor's electromagnetic radiation intensity might meet the exposure level of the medical standard 04 μT in 0.6 meters. Thus drivers and passengers tend to have safer driving in electric vehicles for a long time. Without radiation damage to human body, electric vehicles may be more popular. After the popularity of electric vehicles, electric vehicles will replace the existing gasoline and diesel fuel vehicles to slove the global environment pollution problem fundamentally.

### CROSS-REFERENCE TO RELATED APPLICATION

This is a national stage application for PCT International Application Serial Number PCT/CN2016/082210, filed on May 16, 2016, which claims priority to a Chinese patent application serial number 201510334961.0, filed on Jun. 12, 2015, whose applications are incorporated by reference it their entirety herein.

### TECHNOLOGY FIELD

The invention involves a kind of electric vehicle's drive motor, in particular involves a shielding system that can shield the electromagnetic field generated by the electric vehicle's driving motor to make sure the electromagnetic field strength of the drive motor is less than 0.4 μT.

### BACKGROUND TECHNOLOGY

Electric Vehicle Drive Motor's Electromagnetic Field Intensity and the Safety Analysis
a. the electromagnetic field radiation intensity of electric car's drive motor within 0.6 m is more than 100 μT, causing the driver's body in the high electromagnetic environment for a long time, which is above the medical standards (<0.4 μT) 250 times, which seriously damage the human health. Huang Qingyun, Xie Weidong. New Technology of Electric Vehicle Drive Motor's Electromagnetic Field Intensity Distribution and the Safety Analysis. 2012 (2). After long contact of the magnetic field (greater than 0.4 μT), the pregnant mothers' children are at increasing risk of getting acute lymphoblastic leukemia. When the bedroom's magnetic field intensity is greater than 0.4 mu T, the OR value of childhood leukemia is 2 (95% CI is 1.27-3.13). When the magnetic field intensity exceeds 0.3 mu T, children leukemia OR value is 1.7 (95% CI is 1.2-2.3). Research Progress of Extremely Low Frequency Electromagnetic Field Radiation and Incidence of childhood leukemia. International journal of pediatrics. 2011 (7): 38-4.3.0.2.
b. Chinese patent 201320756168.6; 201310607786.9 discloses a kind of electromagnetic shielding system of electric vehicle's drive motor. The patent is failure for the outer shield layer is single layer. In that way, the motor current generated by the electromagnetic field in the power line can go along part of the power line and radiate electromagnetic field before the power line and the power surge protection devices are connected.

Three Aspects of Electromagnetic Pulse Protection
a. Shielding: Shielding makes use of shielding body to block or reduce the transmission of electromagnetic energy to achieve electromagnetic protection, allowing no electromagnetic field to reach the protected devices.
b. Grounding: Grounding is the connection between the electronic devices and the earth through appropriate methods and approaches in order to improve the stability of electronic equipment and effectively restrain the influence of external electromagnetic field, avoiding the interference and damage caused by discharging, which is cause by charge accumulation.
c. Filter: A filter can be formed into selective network with resistance, inductance and capacitance to achieve the filtering effect. A filter can also be made of lossy material such ferrite to filter. (Reference: Sun yongjun, Principles and Protection of Electromagnetic Pulse [J], Space Electronic Technology, 2004 (3))

The world's most advanced power surge protector (SPD): Signal lines and circuit control protection are the world's leading power purification, precision instrument protection, power surge protection products. The sine wave that can track the filtering and special chemical packaging patent technology includes surge protection and filtering technology, which are in line with the technology requirements of electromagnetic pulse protection. The product (SPD) has the following advantages:

3.1 Because of the multi-level protection mechanism, the residual pressure can reach 0V. The surge voltage after diversion is generally between 2.5 KV˜15 KV. Devices that equipped with SPD can achieve very low residual pressure. (Zero volt can be reached in some special industry) The smaller the residual pressure is, the better the protection effect is.

3.2 Its response speed is less than 1 ns, which can prevent the second lightning, induced lightening and the internal flow of electrical transient voltage suppressor (TVS) effectively.

The response time of TVS two tube is less than 1 ns. The advantages goes as followings: bidirectional protection, fast speed (NS), large power of absorbing surge (transient power up to several kW), clamp voltage is easy to control, low current leakage, no damage limit, small volume.

3.3 The shell adopts NEMA 4 standard, and it is waterproof, fireproof, explosion-proof and anti-static.

3.4 The patented sine wave ORN tracking technology can eliminate surge and harmonic wave accurately. The sine wave ORN with enhanced patent can shift positively and negatively according to a certain sine wave, eliminating the surge “dirty electricity and cleaning the electricity environment, remaining low residual pressure value. In the computer communication system or electronic device, the electromagnetic pulse is coupled to the circuit through conducting wires, and the overvoltage energy of the product is transmitted to the device through the circuit to interfere or damage the equipment. When the wires are coupled, the energy is over voltage. ORN filtering technology can ensure the power and signal “clean” and prevent computer systems or electronic devices from interference or damage of electromagnetic pulse through the tracking technology.

3.5 The one and only chemical packaging patent technology can ensure the devices' reliable performance in a long time. The special chemical seal can rapidly absorb the heat produced during the process of surge protection to protect and prolong the service life of components to protect the security of the system.

3.6 The true 10 mode (full mode) protection can filter waves between lines, blocking all possible channels of surge include blocking the channel between the lines and the ground to create a perfect protection.

3.7 The capacitor design is hybrid multi-module with both thermal insurance and electric insurance.

3.8 The surge protection product is the only one that is earth-free, using patented sine wave tracking technology, special chemical packaging, and nanosecond TVS components, ten mode protection and diversified module to make sure that the product can not release energy through the ground. For the grounding system is not perfect for the military mobile communication system, this product can do the surge filter protection without grounding. (Reference: American Company Product Specification Series)

### DEFICIENCIES OF THE EXISTING TECHNOLOGY

The closed shield has the characteristics of simple structure, convenient manufacture and low cost, and the ultra low frequency electromagnetic shielding device is composed of single-layer high magnetic alloy. Its deficiencies are as follows: 1. The shielding coefficient is low (generally 20˜30 dB); 2. Cannot deal with strong magnetic field and weak magnetic field at the same time; 3. The shielding layer is exposed, which is vulnerable and is easily be impacted. Thus the shielding effectiveness maybe decreased. Therefore, the ultra low frequency electromagnetic shielding device of the single-layer structure is only suitable for low shielding places (electromagnetic shielding coefficient 20˜30 dB; the higher the coefficient of electromagnetic shielding, the higher the requirements of the shielding equipment (electromagnetic shielding coefficient in 75˜90 dB). Even if the shield is thicker, the shield cannot reach the ideal effect.

### DETAILS OF THE INVENTION

There are serious radiation problems in the existing electric vehicle's drive motor whose electromagnetic radiation intensity in 0.6 meters is more than 100 μT, which is more than the exposure level of the medical standard 04 μT, seriously damaging drivers' health. This invention provides an electromagnetic shielding system for electric vehicle's drive motor: the outer shield made of magnetic conductive metal is installed outside the motor and the outer shield body is composed of the top cover and the bottom cover; the first bracket is fixed on the outer surface of the outer shield with the first bolt, the second bracket is fixed on the outer surface of the outer shield with the fourth bolt; the first bracket is fixed on the electric car with the second bolt, the second bracket is fixed to the electric vehicle with the third bolt; inside the outer shield: the first bracket is fixed on the inner surface of the outer shield, 1˜5 signal lines and the line control protector are fixed on the first bracket; the second bracket is fixed on the inner surface of the second outer shield, 1˜5 first power surge protection devices (SPD) are fixed on the second bracket; 1˜5 second power surge protection device (SPD) are fixed on the second bracket. The power line goes into the tube, and then is connected with the first connection wire of the second power surge protection device (SPD) in parallel at the first connection point of the power line. After that, the power line goes into the outer shielding and is connected with the motor terminal box; the second connection line of the power surge protection (SPD) is connected on the inner surface of the outer shield.

The second power surge protector's second connection line is connected to the inner surface of the outer shield. The second power surge protector's second connection line is the protective earth line (PE) of the second power surge protector, and it is connected to the inner surface of the outer layer shield to guide the energy absorbed by the outer layer shield, and the first bracket and the second bracket is connected to the outer shield to guide the energy around the metal by connection to the electric vehicle.

The second connection line of the first power surge protector is connected to the inner surface of the outer shield; the third connection line of the first power surge protector is connected to the outer surface of the motor. The high current causes the motor to energize and generate a strong electromagnetic field, and then the electromagnetic field begins to attack the outer shield. The second connection line of the first power surge protector begins to unload and sink the current induced by the layer shield. After the current is unloaded, the current can not be saturated at the outer shield and the outer shield can not be broken; the first power surge protector's third conductor starts to unload and absorb the current induced on the shell of the motor; the first connection line of the first power surge protector is connected to the inner surface of the outer shied; the first connection line is the protective earth line (PE) of the first power surge protector, and it is connected to the inner surface of the outer shield to guide the energy absorbed by the outer layer of shield, and the first bracket and the second bracket are connected to the outer shield and the electric vehicle to divert the energy. After the signal line enters the conduit, the signal line and the signal line protector's second wire are connected in series or in parallel at the signal line's first connection point, and then the signal line is connected to the speed sensor junction of the motor inside the outer shield. The signal line protector's first wire is connected to the inner surface of the outer shied. The signal line protector's first wire is the protective earth line (PE) of the signal line protector's first wire, and they are connected to the inner surface of the outer shield to guide the energy absorbed by the outer layer of shield, and the first bracket and the second bracket are connected to the outer shield and the electric vehicle to divert the energy.

The cooling liquid outlet and the coolant inlet are made of magnetic conductive metal which are bent to degrees or bent into a spiral to prevent the electromagnetic field generated by the motor from leaking through the tubes; after that, the coolant goes into the cooling liquid inlet, and then goes into the cooling water tank shell through the cooling water pipe and the cooling liquid inlet; the coolant goes out of the cooling water tank shell through the coolant outlet, cooling water pipe and the cooling liquid outlet, reducing the temperature of the motor and inside the outer shield. The coolant outlet and the coolant inlet are respectively connected with the cooling system so that the cooling liquid can flow in circulation. The fan is installed on the motor's drive shaft, and the bearing is mounted on the transmission shaft. The diameter of the fan is greater than the diameter of the bearing to prevent the large current in the motor from causing the induction coil to generate strong electromagnetic fields which can leak through the bearing and go out of the outer shield.

The power supply surge protector (SPD) is connected in parallel with the power line in the circuit.

The rabbet is fixed inside the shell, the center bearing is fixed in the rabbet. The cooling water tank shell is circular, and the cooling liquid inlet and the cooling liquid outlet are fixed on the shell's arc surface. The cooling water tank shell is inserted separately in the circular groove of the top cover and in the circular groove of the bottom cover; the top cover and the bottom cover are respectively fixed on the ends of shell with the first fixing screw and second fixing screw; the first bearing chamber is fixed in the center bearing; the second bearing chamber is fixed on the top cover; the rotating shaft is fixed on the top cover and the first bearing chamber of the center bearing, the stator is fixed on the inner wall of the shell which is the top part of the center bearing, the rotor is fixed on the rotating shaft, the speed sensor is fixed on the inner surface of the bottom cover, the speed sensor terminal box is fixed outside of the bottom cover, the speed sensor is connected with the speed sensor terminal box in the bottom cover.

The outer shield's top cover and the bottom cover are fixed separately at the first joint and the second joint with the outer shield's screw. The outer interface and the outer shield's top cover and bottom cover are connected in a convex concave staggered state to prevent the leakage of electromagnetic shield.

The installation of the motor's top bracket and bottom bracket is composed of the following: the motor bearing bracket is fixed with the fixed leg, the fixed leg is sheathed on the supporting bracket to achieve positioning. The supporting base is fixed to the supporting bracket, and the supporting base is fixed with two supporting leg sections that are put in parallel, which include the first supporting foot and the second supporting legs (the two supporting feet are arranged at intervals). And the upper motor bearing bracket is fixed on the first supporting feet and the second supporting feet. The supporting base is a rectangular frame, and the first supporting foot and the second supporting feet are respectively fixed on the four corners of the rectangular frame. The motor bearing bracket's cross section is curved, and the motor's fastening component may comprise the thrust block that is fixed on the fixed seat and the adjusting bolt that is fixed in the upper motor support bracket, and the thrust block is connected and inserted on the fixed seat with the screw. The motor is put on the bearing bracket that is fixed on the motor bottom bracket, and the adjusting bolt makes the rubber thrust block press on the shell of the motor. Then the adjusting bolt penetrates the rubber thrust block and is screwed together with the (motor's bottom support frame connection's) screw to fasten the motor. Make the screw pass through the bottom cover of the outer shield to bolt the bracket with the bottom cover together, forming a whole body with the bracket and the bottom cover; put the motor top bracket on the top of the motor, and adjust the adjusting bolt to make the rubber thrust blocks press the motor, then make the adjusting bolt penetrate the rubber thrust block to screw the adjusting bolt and the (motor's top support frame connection′) screw together to fasten the motor, and make the screw pass through the top cover of the outer shield to bolt the bracket with the top cover together, forming a whole body with the bracket and the top cover;

The fan consists of the first blade and the second blade, and the first blade includes the third blade and the fourth blade. And the first blade and the second blade are in front of the bottom cover, the second blade is between the third blade and the fourth blade. The blade of the first blade is from a centrifugal fan, while the second blade is similar to the axial fan blade. The wind from the second blade can enter the first cooling ventilation tube, and the second blade has a main tangential air inlet and a secondary radial air inlet, which lead to negative pressure in center area of the fan. The outside cold air goes into the fan, then the air flows through two path under the impact of the second blade. The outer tube is welded to the external shell of the shield, and the inner tube is welded to the internal of the shield. The outer tube and the inner tube are connected closely at the junction inside the shield, forming the tube. The tube can be made into the first cooling vent tube, the second cooling vent tube, power line tube and signal line tube; the tube is made of magnetic conductive metal, and the tube is bent to degrees or bent into a spiral shape on both sides to prevent the electromagnetic field generated by the motor from leaking through the pipeline.

The power line enters the tube and is connected in parallel with the second power surge protector's first connection line at the power line's first connection point. Then the power line enters the outer shield and is connected with the motor junction box; the power line's first connection point is located at the connection point of the power line tube; when the motor is energized, the high current causes the induction coil to generate strong electromagnetic field and the power line will induct current, and the second power surge protector's (SPD) first connection line can absorb the inducted current, preventing the large current from passing along the power line and the power line tube to stop inducing strong magnetic field.

The signal line goes into the tube, then it is connected to the second wire of the signal protector in parallel at the first signal line's connection point. After that, the signal line is connected with the speed sensor's connection box of the motor inside the outer shield; the first signal line's connection point is located at connection spot of the tube. When the motor 8 is energized, the induction coil will produce strong electromagnetic field, and the signal line can induct current. Then the signal line protector's second wire can unload and absorb the inducted current to prevent the current from leaking and inducting strong magnetic field by passing through the signal line and tube.

The beneficial effect of invention is as follows: The drive motor's power surge protection devices, signal lines and control line protection devices are installed between the outer shield and the drive motor to absorb and unload the induced current which is caused by the motor's electromagnetic field around the power lines and signal lines. In this way, the induced current cannot penetrate the shield and form another strong magnetic field, and the drive motor's electromagnetic radiation intensity can meet the exposure level of the medical standard 04 μT in 0.6 meters. Thus drivers and passengers can go for a safe drive in the electric vehicle for a long time.

### FIGURE ATTACHMENT

FIG. 1 The schematic diagram of the invention's structure;

FIG. 2 The top view of the invention;

FIG. 3 The schematic diagram of the circuit;

FIG. 4 The schematic diagram of the circuit;

FIG. 5 The schematic diagram of the electric motor;

FIG. 6 The sketch map of the top and bottom cover plates of the outer shield;

FIG. 7 The three-dimensional sketch of the scaffold;

FIG. 8 The stereoscopic representation of the bracket;

FIG. 9 The schematic diagram of the three-dimensional positive structure of a fan;

FIG. 10 The schematic diagram of the shielding tube's structure;

FIG. 11 The structural diagram of the power line's first connection point;

FIG. 12 The structural diagram of the signal line's first connection point;

### SPECIFIC IMPLEMENTATION METHODS

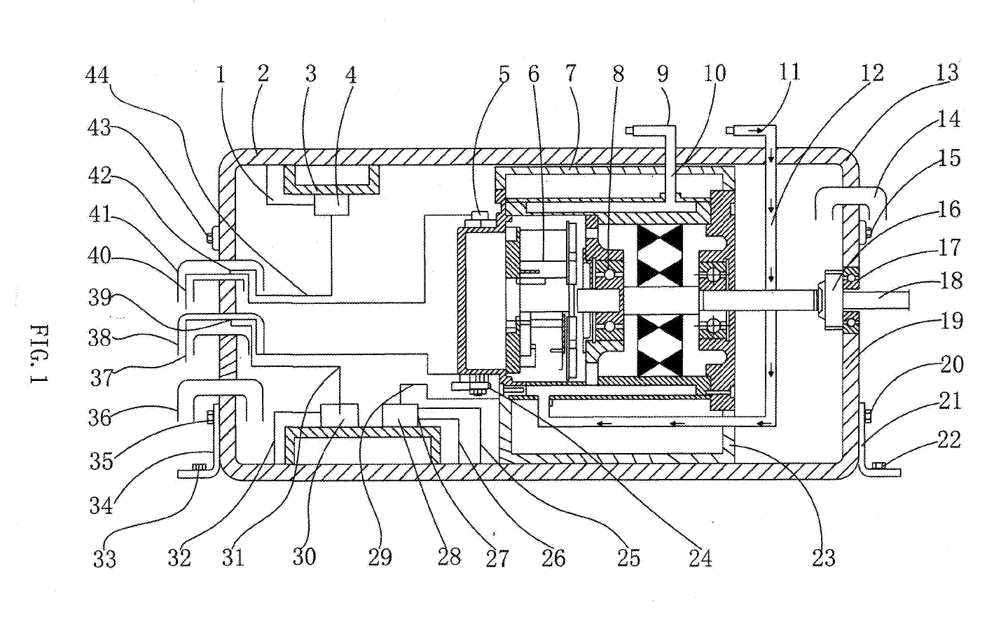

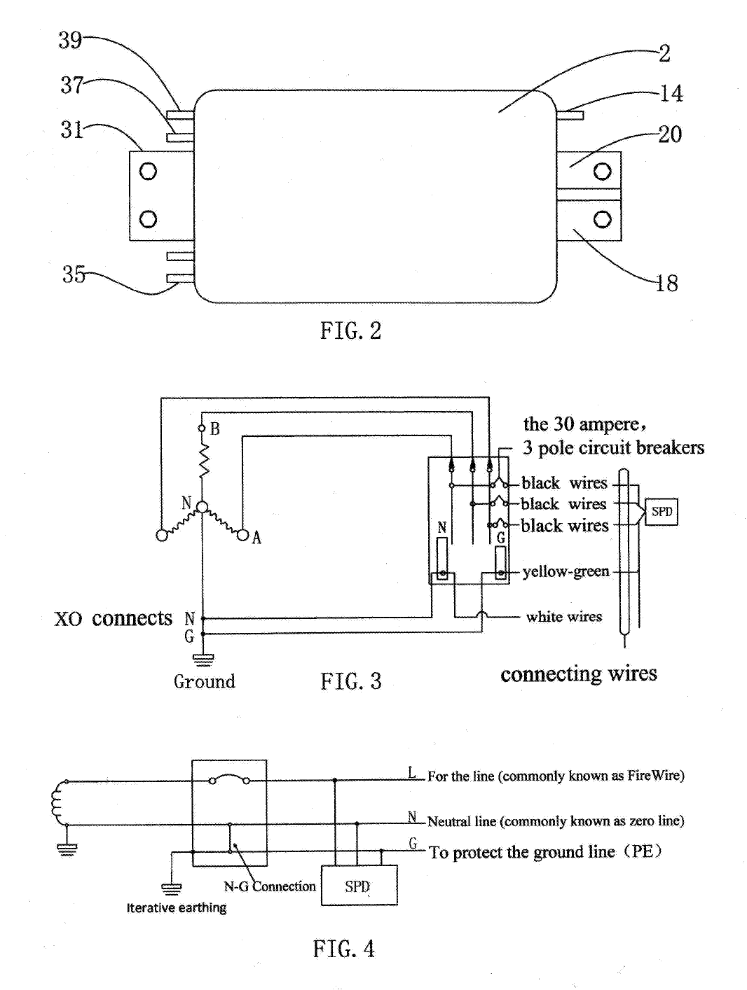

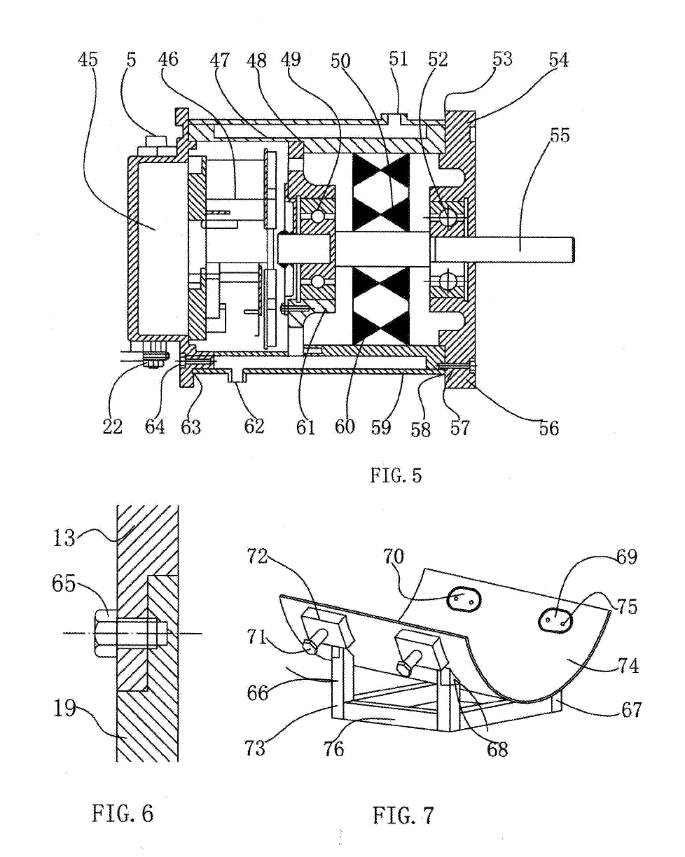

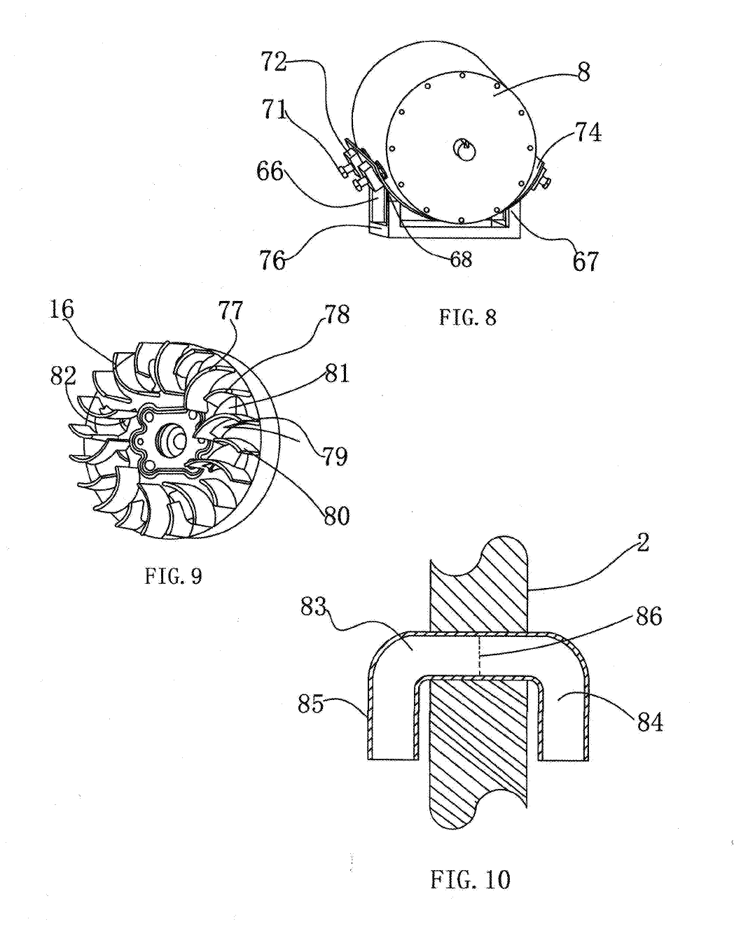

In FIG. 1, FIG. 2, FIG. 5, FIG. 7 and FIG. 8, one layer of magnetic conductive shield 2 is installed outside of the motor 8, the outer shield 2 consists of an upper shield cover 13 and a bottom shield cover 19; the first bracket 21 is fixed on the outer surface of the shield 2 with the first bolt 20, the second bracket 34 is fixed on the outer surface of the shield 2 with the fourth bolt 35; the first bracket 21 is fixed on the electric car by the second bolt 22, the second bracket 34 is fixed on the electric vehicle with the third bolt 33; inside the outer shield 2: one first bracket 3 is fixed on the inner surface of the outer shield 1, one signal line protector 4 is fixed on the first bracket 3; one second bracket 27 is fixed on the inner surface of the outer shield 2, one first power surge protector 28 is fixed on the second bracket 27; one second power surge protector 30 is fixed on the second bracket 27. After the power supply line 37 enters the power supply line's conduit 38, the power supply line 37 and the first connecting line 31 of the second power surge protector 30 are connected in parallel at the power supply line's first connecting point 39, and then the power supply line 37 is connected to the motor connecting box 24 inside the outer shield 2; the second power surge protector's second connecting line 32 is connected to the inner surface of the outer shield 2. The second power surge protector's second connecting line 32 is the protective earth line (PE) of the second power surge protector 30, and it is connected to the inner surface of the outer shield 2 to guide the energy absorbed by the outer layer of shield 2, and the first bracket 21 and the second bracket 34 are connected to the outer shield 2 and the electric vehicle to divert the energy.

The second connecting line 26 of the first power surge protector 28 is connected to the inner surface of the outer shield 2; the third connecting line 29 of the first power surge protector 28 is connected to the outer surface of the motor 8. The high current causes the motor 8 to energize and generate a strong electromagnetic field, and then the electromagnetic field begins to attack the outer shield 2. The second connecting line 26 of the first power surge protector 28 begins to unload and sink the current induced by the layer shield 2. After the current is unloaded, the current can not be saturated at the outer shield 2 and the outer shield 2 can not be broken; the first power surge protector 28's third conductor 29 starts to unload and absorb the current induced on the shell 47 of the motor 8; the first connecting line 25 of the first power surge protector 28 is connected to the inner surface of the outer shied 2; the first connecting line 25 is the protective earth line (PE) of the first power surge protector 28, and it is connected to the inner surface of the outer shield 2 to guide the energy absorbed by the outer layer of shield 2, and the first bracket 21 and the second bracket 34 are connected to the outer shield 2 and the electric vehicle to divert the energy. After the signal line 40 enters the conduit 41, the signal line 40 and the signal line protector 4's second wire 44 are connected in series or in parallel at the signal line's first connecting point 42, and then the signal line 40 is connected to the speed sensor junction 5 of the motor 8 inside the outer shield 2. The signal line protector's first wire 1 is connected to the inner surface of the outer shied 2. The signal line protector's first wire 1 is the protective earth line (PE) of the signal line protector's first wire 4, and they are connected to the inner surface of the outer shield 2 to guide the energy absorbed by the outer layer of shield 2, and the first bracket 21 and the second bracket 34 are connected to the outer shield 2 and the electric vehicle to divert the energy.

The cooling liquid outlet 9 and the coolant inlet 11 are made of magnetic conductive metal which are bent to 90 degrees or bent into a spiral to prevent the electromagnetic field generated by the motor 8 from leaking through the tubes; after that, the coolant goes into the cooling liquid inlet 11, and then goes into the cooling water tank shell 58 through the cooling water pipe 12 and the cooling liquid inlet 61; the coolant goes out of the cooling water tank shell 58 through the coolant outlet 51, cooling water pipe 10 and the cooling liquid outlet 9, reducing the temperature of the motor 8 and inside the outer shield 2. The coolant outlet 9 and the coolant inlet 11 are respectively connected with the cooling system so that the cooling liquid can flow in circulation. The fan 16 is installed on the motor 8's drive shaft 18, and bearing 17 is mounted on the transmission shaft 18. The diameter of the fan 16 is greater than the diameter of the bearing 17 to prevent the large current in the motor 8 cause the induction coil to generate strong electromagnetic fields which can leak through the bearing 17 and go out of the outer shield 2.

In FIG. 3 and FIG. 4, the power supply surge protector (SPD) is connected in parallel with the power line in the circuit.

In FIG. 5, the rabbet 48 is fixed inside the shell 47, the center bearing 61 is fixed in the rabbet 48. The cooling water tank shell 59 is circular, and the cooling liquid inlet 62 and the cooling liquid outlet 51 are fixed on the shell's arc surface. The cooling water tank shell 59 is inserted separately in the circular groove 58 of the front cover and in the circular groove 63 of the back cover; the front cover 54 and the back cover 45 are respectively fixed on the ends of shell 47 with the first fixing screw 57 and second fixing screw 64; the first bearing chamber 49 is fixed in the center bearing 61; the second bearing chamber 52 is fixed on the front cover 54; the rotating shaft 18 is fixed on the front cover 54 and the first bearing chamber 49 of the center bearing 61, the stator 60 is fixed on the inner wall of the shell 47 which is the front part of the center bearing 61, the rotor 50 is fixed on the rotating shaft 18, the speed sensor 46 is fixed on the inner surface of the back cover 45, the speed sensor terminal box 5 is fixed outside of the back cover 45, the speed sensor 46 is connected with the speed sensor terminal box 5 in the back cover 45.

In FIG. 6, the outer shield 2's front cover 13 and the back cover 19 are fixed separately at the first 15 joint and second joint 43 parts the outer shield screw 65 to the outer shield, to prevent the leakage of electromagnetic shield on the outer interface and the outer shield under cover 13 the cover 19 is a convex concave staggered state together.

In FIG. 7, FIG. 8, FIG. 13, FIG. 14, FIG. 15 and FIG. 16, the installation with the top bracket 7 and the bottom bracket 23 in the motor is composed of the following: the motor bearing bracket 74 is fixed with the fixed leg 68, the fixed leg 68 is sheathed on the supporting bracket 73 to achieve positioning. The supporting base 76 is fixed to the supporting bracket 73, and the supporting base 76 is fixed with two supporting leg sections that are put in parallel, which include the first supporting foot 66 and the second supporting legs 67 (the two supporting feet are arranged at intervals). And the upper motor bearing bracket 63 is fixed on the first supporting feet 66 and the second supporting feet 67. The supporting base 76 is a rectangular frame, and the first supporting foot 66 and the second supporting feet 67 are respectively fixed on the four corners of the rectangular frame 76. The motor bearing bracket 74's cross section is curved, and the motor fastening component 70 may comprise the thrust block 69 that is fixed on the fixed seat 72 and the adjusting bolt 71 that is fixed in the upper motor support bracket 74, and the thrust block 69 is connected and inserted on the fixed seat 72 with the screw 75. The motor 8 is put on the bearing bracket 63 that is fixed on the motor bottom bracket 23, and the adjusting bolt 71 makes the rubber thrust block 69 press on the shell of the motor 8. Then the adjusting bolt 71 penetrates the rubber thrust block 69 and is screwed together with the (motor's bottom support frame connecting) screw 56 to fasten the motor 8. Make the screw 87 pass through the bottom cover 19 of the outer shield to bolt the bracket 23 with the bottom cover together, forming a whole body with the bracket 23 and the bottom cover 19; put the motor top bracket 7 on the top of the motor 8, and adjust the adjusting bolt 71 to make the rubber thrust blocks 69 press the motor 8, then make the adjusting bolt 71 penetrate the rubber thrust block 69 to screw the adjusting bolt 71 and the (motor's top support frame connecting) screw 53 together to fasten the motor, and make the screw 87 pass through the top cover 13 of the outer shield to bolt the bracket 7 with the top cover together, forming a whole body with the bracket 7 and the top cover 13;

In FIG. 9, the fan 16 consists of the first blade 80 and the second blade 81, and the first blade 80 includes the third blade 77 and the fourth blade 78. And the first blade 80 and the second blade 81 are in front of the bottom cover, the second blade 81 is between the third blade 77 and the fourth blade. The blade of the first blade 80 is from centrifugal fan, while the second blade 84 is similar to the axial fan blade. The wind from the second blade 84 can enter the first cooling ventilation tube 14, and the second blade 81 has a main tangential air inlet 79 and a secondary radial air inlet 82, which lead to negative pressure in center area of the fan 16. The outside cold air goes into the fan 16, then the air flows through two path under the impact of the second blade 81.

In FIG. 10, the outer tube 83 is welded to the external shell of the shield 2, and the inner tube 84 is welded to the internal of the shield 2. The outer tube 83 and the inner tube 84 are connected closely at the junction 86 inside the shield 2, forming the tube 85. The tube 85 can be made into the first cooling vent tube 14, the second cooling vent tube 36, power line tube 38 and signal line tube 41; The tube 85 is made of magnetic conductive metal, and the tube is bent to 90 degrees or bent into a spiral shape on both sides to prevent the electromagnetic field generated by the motor 8 leak through the pipeline.

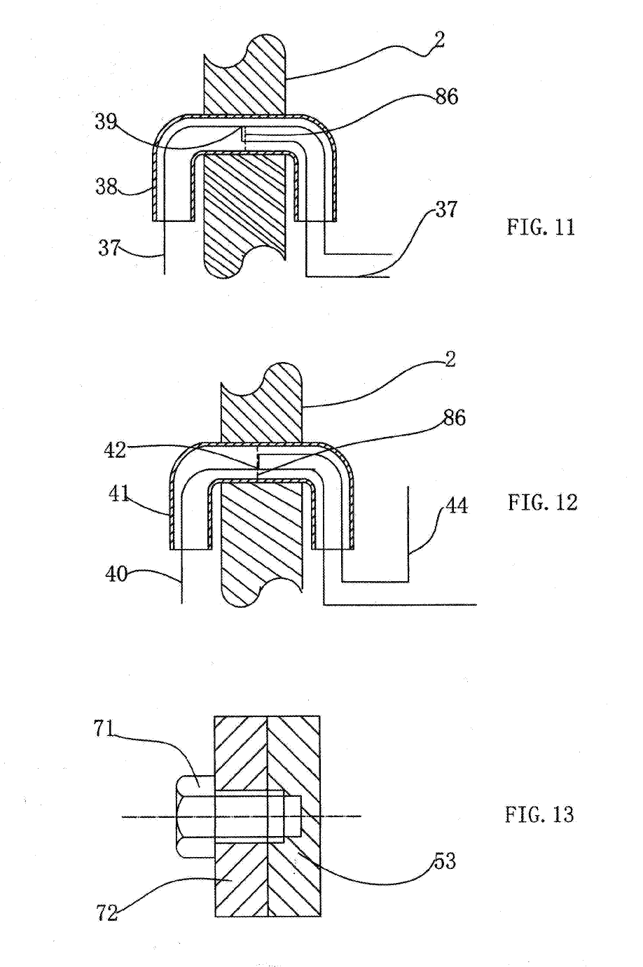

In FIG. 11 and FIG. 10, the power line 37 enters the tube 38 and is connected in parallel with the second power surge protector's first connection line 31 at the power line's first connection point 39. Then the power line 37 enters the outer shield 2 and is connected with the motor junction box 24; the power line's first connection point 39 is located at the connection point 86 of the power line tube 38; when the motor 8 is energized, the high current causes the induction coil to generate strong electromagnetic field and the power line 37 will induct current, and the second power surge protector (SPD) 30′first connecting line 31 can absorb the inducted current, preventing the large current from passing along the power line 37 and the power line tube 38 to stop inducing strong magnetic field.

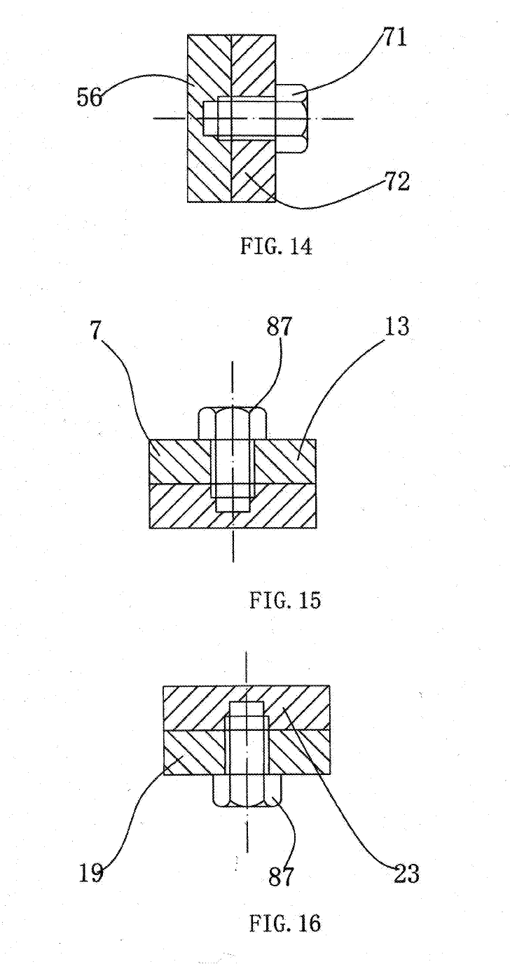

In FIG. 12 and FIG. 10, the signal line 40 goes into the tube 41, then it is connected to the second wire 44 of the signal protector in parallel at the first signal line's connecting point 42. After that, the signal line 40 is connected with the speed sensor's connecting box 8 of the motor 8 inside the outer shield 2; the first signal line's connecting point 42 is located at connecting spot 86 of the tube 41. When the motor 8 is energized, the induction coil will produce strong electromagnetic field, and the signal line 40 can induct current. Then the signal line protector 4's second wire 44 can unload and absorb the inducted current to prevent the current from leaking and inducting strong magnetic field by passing through the signal line 40 and tube 41.

What is claimed is:

1. The features of an electromagnetic shielding system controlled by the motor of electric vehicles: The signal line (40) enters the tube (41) and is connected in parallel with the second signal line protector's second signal line (44) at the signal line's first connection point (42), Then the signal line 40 enters the outer shield (2) and is connected with the speed sensor terminal box of the motor (8), The power line (37) enters the tube 38 and is connected in parallel with the second power surge protector's first connection line (31) at the power line's first connection point (39) Then the power line (37) enters the outer shield (2) and is connected with the motor junction box (24), The first power surge protection's second connection line (26) of the first power surge protection device (28) is connected to the inner surface of the outer shield (2); the third wire (28) of the first power surge protection device (29) is connected to the external surface of the motor (8), the first wire (25) of the first power surge protector (28) is connected to the inner surface of the outer shield (2); the first wire (25) of the first power surge protection device (28) is the protective earth wire (PE).

2. According to claim 1, the features of an electromagnetic shielding system controlled by the motor of electric vehicles: One layer of magnetic conductive shield (2) is installed outside of the motor (8), the outer shield (2) consists of an upper shield cover (13) and a bottom shield cover (19); inside the outer shield (2): one first bracket (3) is fixed on the inner surface of the outer shield 1, 1˜5 signal line and one signal line protector (4) are fixed on the first bracket (3); one second bracket (27) is fixed on the inner surface of the outer shield (2), 1˜5 first power surge protector (28) are fixed on the second bracket (27); 1˜5 second power surge protector 30 are fixed on the second bracket (27).

3. According to claim 1, the features of an electromagnetic shielding system controlled by the motor of electric vehicles: One layer of magnetic conductive shield (2) is installed outside of the motor (8), the outer shield (2) consists of an upper shield cover (13) and a bottom shield cover (19); inside the outer shield (2): one first bracket (3) is fixed on the inner surface of the outer shield 1, 1 signal line and one signal line protector (4) are fixed on the first bracket (3); one second bracket (27) is fixed on the inner surface of the outer shield (2), 1 first power surge protector (28) are fixed on the second bracket (27); 1 second power surge protector (30) are fixed on the second bracket (27).

4. According to claim 1, the features of an electromagnetic shielding system controlled by the motor of electric vehicles: one layer of magnetic conductive shield (2) is installed outside of the motor (8), the outer shield (2) consists of an upper shield cover (13) and a bottom shield cover (19); the first bracket (21) is fixed on the outer surface of the shield (21) with the first bolt (20), the second bracket (34) is fixed on the outer surface of the shield (2) with the fourth bolt (35); the first bracket (21) is fixed on the electric car by the second bolt (22), the second bracket (34) is fixed on the electric vehicle with the third bolt (33); inside the outer shield (2): one first bracket (3) is fixed on the inner surface of the outer shield (1), one signal line protector (4) is fixed on the first bracket (3); one second bracket (27) is fixed on the inner surface of the outer shield (2), one first power surge protector (28) is fixed on the second bracket (27); one second power surge protector (30) is fixed on the second bracket (27), After the power supply line (37) enters the power supply line's conduit (38), the power supply line (37) and the first connecting line (31) of the second power surge protector (30) are connected in parallel at the power supply line's first connecting point (39), and then the power supply line (37) is connected to the motor connecting box (24) inside the outer shield (2); the second power surge protector's second connecting line (32) is connected to the inner surface of the outer shield (2), The second power surge protector's second connecting line (32) is the protective earth line (PE) of the second power surge protector (30), and it is connected to the inner surface of the outer shield (2) to guide the energy absorbed by the outer layer of shield (2), and the first bracket (21) and the second bracket (34) are connected to the outer shield (2) and the electric vehicle to divert the energy, The second connecting line (26) of the first power surge protector (28) is connected to the inner surface of the outer shield (2); the third connecting line (29) of the first power surge protector (28) is connected to the outer surface of the motor (8), The high current causes the motor (8) to energize and generate a strong electromagnetic field, and then the electromagnetic field begins to attack the outer shield (2), The second connecting line (26) of the first power surge protector (28) begins to unload and sink the current induced by the layer shield (2), After the current is unloaded, the current can not be saturated at the outer shield (2) and the outer shield (2) can not be broken; the first power surge protector (28)'s third conductor (29) starts to unload and absorb the current induced on the shell (47) of the motor 8; the first connecting line (25) of the first power surge protector (28) is connected to the inner surface of the outer shied (2); the first connecting line (25) is the protective earth line (PE) of the first power surge protector (28), and it is connected to the inner surface of the outer shield (2) to guide the energy absorbed by the outer layer of shield (2), and the first bracket (21) and the second bracket (34) are connected to the outer shield (2) and the electric vehicle to divert the energy, After the signal line (40) enters the conduit (41), the signal line (40) and the signal line protector (4)'s second wire (44) are connected in series or in parallel at the signal line's first connecting point (42), and then the signal line (40) is connected to the speed sensor junction (5) of the motor (8) inside the outer shield (2), The signal line protector's first wire 1 is connected to the inner surface of the outer shied (2), The signal line protector's first wire 1 is the protective earth line (PE) of the signal line protector's first wire (4), and they are connected to the inner surface of the outer shield (2) to guide the energy absorbed by the outer layer of shield (2), and the first bracket (21) and the second bracket (34) are connected to the outer shield (2) and the electric vehicle to divert the energy, The cooling liquid outlet (9) and the coolant inlet (11) are made of magnetic conductive metal which are bent to 90 degrees or bent into a spiral to prevent the electromagnetic field generated by the motor (8) from leaking through the tubes; after that, the coolant goes into the cooling liquid inlet (11), and then goes into the cooling water tank shell (58) through the cooling water pipe (12) and the cooling liquid inlet (61); the coolant goes out of the cooling water tank shell (58) through the coolant outlet (51), cooling water pipe (10) and the cooling liquid outlet (9), reducing the temperature of the motor (8) and inside the outer shield (9), The coolant outlet (9) and the coolant inlet (11) are respectively connected with the cooling system so that the cooling liquid can flow in circulation, The fan (16) is installed on the motor (8)'s drive shaft (18), and bearing (17) is mounted on the transmission shaft (18), The diameter of the fan (16) is greater than the diameter of the bearing (17) to prevent the large current in the motor (8) cause the induction coil to generate strong electromagnetic fields which can leak through the bearing (17) and go out of the outer shield (2), In FIG. 3) and FIG. 4), the power supply surge protector is connected in parallel with the power line in the circuit, the rabbet (48) is fixed inside the shell (47), the center bearing (61) is fixed in the rabbet 48, The cooling water tank shell (59) is circular, and the cooling liquid inlet (62) and the cooling liquid outlet (51) are fixed on the shell's arc surface, The cooling water tank shell (59) is inserted separately in the circular groove (58) of the front cover and in the circular groove (63) of the back cover; the front cover (54) and the back cover (45) are respectively fixed on the ends of shell (47) with the first fixing screw (57) and second fixing screw (64); the first bearing chamber (49) is fixed in the center bearing (61); the second bearing chamber (52) is fixed on the front cover (54); the rotating shaft (18) is fixed on the front cover (54) and the first bearing chamber (49) of the center bearing (61), the stator 60 is fixed on the inner wall of the shell (47) which is the front part of the center bearing (61), the rotor (50) is fixed on the rotating shaft (18), the speed sensor (46) is fixed on the inner surface of the back cover (45), the speed sensor terminal box (5) is fixed outside of the back cover (45), the speed sensor (46) is connected with the speed sensor terminal box (5) in the back cover (45), the outer shield (2)'s front cover (13) and the back cover (19) are fixed separately at the first (15) joint and second joint (43) parts the outer shield screw (65) to the outer shield, to prevent the leakage of electromagnetic shield on the outer interface and the outer shield under cover (13) the cover (19) is a convex concave staggered state together, the installation with the top bracket (7) and the bottom bracket (23) in the motor is composed of the following: the motor bearing bracket (74) is fixed with the fixed leg (68), the fixed leg (68) is sheathed on the supporting bracket (73) to achieve positioning, The supporting base (76) is fixed to the supporting bracket (73), and the supporting base (76) is fixed with two supporting leg sections that are put in parallel, which include the first supporting foot (66) and the second supporting legs (67) (the two supporting feet are arranged at intervals), And the upper motor bearing bracket (63) is fixed on the first supporting feet (66) and the second supporting feet (67), The supporting base (76) is a rectangular frame, and the first supporting foot (66) and the second supporting feet (67) are respectively fixed on the four corners of the rectangular frame (76), The motor bearing bracket (74)'s cross section is curved, and the motor fastening component (70) may comprise the thrust block (69) that is fixed on the fixed seat (72) and the adjusting bolt (71) that is fixed in the upper motor support bracket (74), and the thrust block (69) is connected and inserted on the fixed seat (72) with the screw (75), The motor (8) is put on the bearing bracket (63) that is fixed on the motor bottom bracket (23), and the adjusting bolt (71) makes the rubber thrust block (69) press on the shell of the motor (8), Then the adjusting bolt (71) penetrates the rubber thrust block (69) and is screwed together with the (motor's bottom support frame connecting) screw (56) to fasten the motor (8), Make the screw (87) pass through the bottom cover (19) of the outer shield to bolt the bracket (23) with the bottom cover together, forming a whole body with the bracket (23) and the bottom cover (19); put the motor top bracket (7) on the top of the motor (8), and adjust the adjusting bolt (7) 1 to make the rubber thrust blocks (69) press the motor (8), then make the adjusting bolt (71) penetrate the rubber thrust block (69) to screw the adjusting bolt (71) and the (motor's top support frame connecting) screw (53) together to fasten the motor, and make the screw (87) pass through the top cover (13) of the outer shield to bolt the bracket (7) with the top cover together, forming a whole body with the bracket (7) and the top cover (13); the fan 16 consists of the first blade (80) and the second blade (81), and the first blade 80 includes the third blade (77) and the fourth blade (78), And the first blade (80) and the second blade (81) are in front of the bottom cover, the second blade (81) is between the third blade (77) and the fourth blade, The blade of the first blade (80) is from centrifugal fan, while the second blade (84) is similar to the axial fan blade, The wind from the second blade (84) can enter the first cooling ventilation tube (14), and the second blade (81) has a main tangential air inlet (79) and a secondary radial air inlet (82), which lead to negative pressure in center area of the fan (16), The outside cold air goes into the fan (16), then the air flows through two path under the impact of the second blade (81), In FIG. 10), the outer tube (83) is welded to the external shell of the shield (2), and the inner tube (84) is welded to the internal of the shield (2), The outer tube (83) and the inner tube (84) are connected closely at the junction 86 inside the shield (2), forming the tube (85), The tube (85) can be made into the first cooling vent tube (14), the second cooling vent tube (36), power line tube (38) and signal line tube (41); The tube (85) is made of magnetic conductive metal, and the tube is bent to 90 degrees or bent into a spiral shape on both sides to prevent the electromagnetic field generated by the motor (8) leak through the pipeline, the power line (37) enters the tube (38) and is connected in parallel with the second power surge protector's first connection line (31) at the power line's first connection point (39), Then the power line (37) enters the outer shield (2) and is connected with the motor junction box (24); the power line's first connection point (39) is located at the connection point 86 of the power line tube (38); when the motor (8) is energized, the high current causes the induction coil to generate strong electromagnetic field and the power line (37) will induct current, and the second power surge protector (30) ‘first connecting line (31) can absorb the inducted current, preventing the large current from passing along the power line (37) and the power line tube (38) to stop inducing strong magnetic field, the signal line (40) goes into the tube (41), then it is connected to the second wire (44) of the signal protector in parallel at the first signal line's connecting point (42), After that, the signal line (40) is connected with the speed sensor's connecting box (8) of the motor (8) inside the outer shield (2); the first signal line's connecting point (42) is located at connecting spot (86) of the tube (41), When the motor (8) is energized, the induction coil will produce strong electromagnetic field, and the signal line (40) can induct current, Then the signal line protector (4)'s second wire (44) can unload and absorb the inducted current to prevent the current from leaking and inducting strong magnetic field by passing through the signal line (40) and tube (41).
